(19) United States
(12) Patent Application Publication
(10) Pub. No.: US 2007/0292127 A1
(43) Pub. Date: Dec. 20, 2007

(54) Small form factor camera module with lens barrel and image sensor

(76) Inventors: Jochen Kuhmann, Berlin (DE); Andreas Alfred Hase, Berlin (DE); Ralf Hauffe, Berlin (DE); Arnd Kilian, Berlin (DE)

Correspondence Address: FISH & RICHARDSON P.C., P.O. BOX 1022, MINNEAPOLIS, MN, 55440-1022, US

(21) Appl. No.: 11/471,414

(22) Filed: Jun. 19, 2006

(51) Int. Cl. G03B 17/00

(52) U.S. Cl. 396/529

(57) ABSTRACT

A camera module includes an image sensor substrate including image sensor circuitry, and a lens barrel. A lid structure includes a transparent window and is disposed between, and attached to, the lens barrel and the image sensor substrate. The lid structure may be fabricated as part of a wafer-level process.

### TECHNICAL FIELD

This disclosure relates to camera modules with a lens barrel and image sensor.

### BACKGROUND

Camera modules, such as CMOS sensor modules, currently are used in a variety of applications, including digital cameras and cell phones. In recent years, image sensor device production has significantly increased, largely as a result of the growing market for cell phones with cameras, which represent one of the most popular consumer devices for taking digital pictures.

FIG. 1 illustrates an example of a known fixed-focus camera module design, which includes a stacked-die version in which the image sensor is on top of a signal-processing die. The fixed-focus lens system includes a mount, a lens barrel, infra-red (IR) filter and multiple lens elements. The number of lens elements varies with optical design requirements. The IR filter eliminates longer-wavelength radiation, which creates noise in the sensor. A flexible circuit with passive components is attached to the bottom of the laminate substrate.

Recently, some mobile phone manufacturers have begun to develop an industry standard, Standard Mobile Imaging Architecture (SMIA) 1.0, to define the mechanical design, high speed serial interface, performance characterizations and functions of camera modules used in mobile handsets. The standard is based, in part, on assembling a CMOS chip on a multilayered printed circuit board (PCB) and subsequently adding the lens barrel.

One of the challenges facing the industry relates to particle control during assembly of the camera module. Particles are a primary cause of yield loss in camera module assembly because a high percentage of defects are related to particles. Particles may be present inside the camera module, yet may not even be detected during testing. Particles on the order of a pixel size and larger may block several pixels, thus resulting in serious quality issues for the camera module manufacturers.

### SUMMARY

This disclosure relates to an image sensor assembly that can be integrated, for example, into a small camera module in which the image sensor is combined with a lens barrel.

The camera module includes an image sensor substrate including image sensor circuitry, and a lens barrel. A lid structure includes a transparent window and is disposed between, and attached to, the lens barrel and the image sensor substrate. The lid structure can be fabricated, for example, as part of a wafer-level process and can be bonded to the image sensor substrate.

Methods of fabricating the lid structure and the image sensor assembly are disclosed as well.

In some implementations, the lid structure can help protect the image sensor from dust or other small particles. Cut-out regions in the lid structure can provide room for alignment features on the lens barrel to facilitate passive alignment of the lens barrel with the image sensor circuitry.

Other features and advantages may be apparent from the following detailed description, the accompanying drawings and the claims.

### BRIEF DESCRIPTION OF THE DRAWINGS

FIG. 1 illustrates a known fixed-focus camera module design.

FIG. 2 illustrates a cross-section of an image sensor assembly according to an implementation of the present invention.

FIGS. 3A and 3B are views of the image sensor assembly.

FIGS. 4 through 7 illustrate an example of a fabrication process for a lid structure for the image sensor assembly.

FIGS. 8A and 8B illustrate re-routing electrical contacts through the lid structure.

FIGS. 9A through 9J illustrate a wafer-level fabrication process for a silicon/glass composite lid structure.

FIGS. 10A through 10F illustrate a wafer-level fabrication process for a glass lid structure.

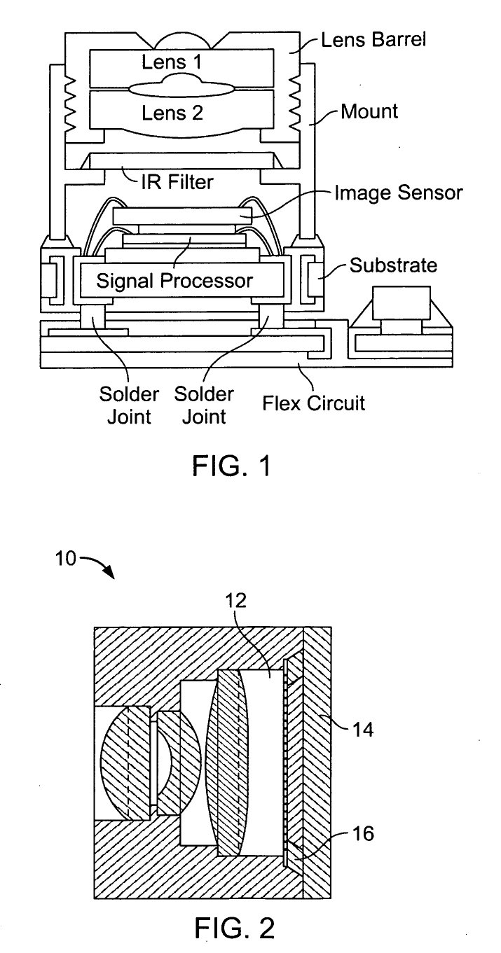

### DETAILED DESCRIPTION

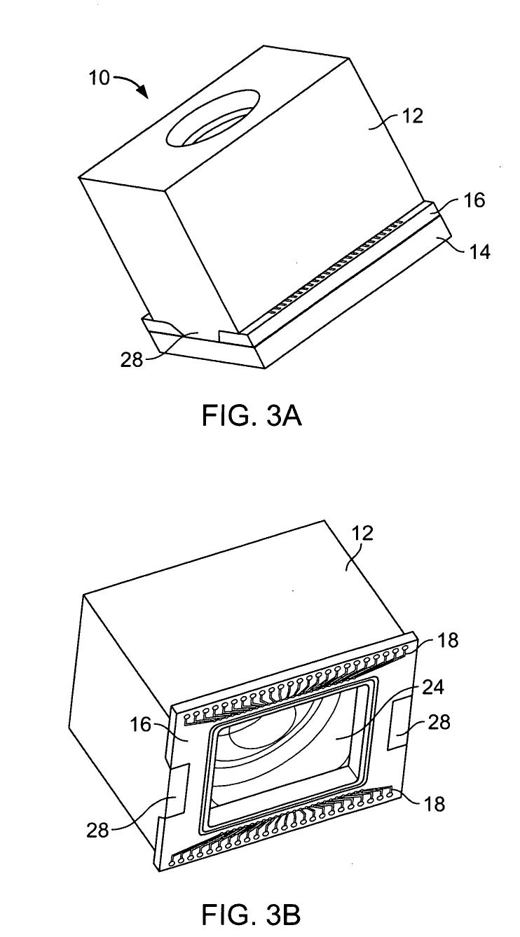

FIG. 2 illustrates a cross-section of an image sensor assembly 10 according to an implementation of the present invention. The assembly 10 includes a lens barrel 12, a CMOS imaging sensor 14 and a lid structure 16 that covers the imaging sensor. The lid structure 16, which is described in greater detail below, includes a glass or other transparent window 24 (see FIG. 3B) in its center region to allow light signals to pass from the lens barrel 12 to the CMOS imaging sensor 14. The structure 16 can help protect the imaging sensor from dust or other particles and, in some cases, provides a hermetic enclosure.

As shown in FIG. 2, the lid structure 16, which is substantially planar, is disposed between the lens barrel 12 and the imaging sensor 14. The lens barrel 12 may include multiple lenses. In the example of FIG. 2, the lens barrel includes three spherical lenses. Other implementations can include a different number or different type of lenses.

FIG. 3A illustrates the image sensor assembly 10 including the top of the lens barrel 12. FIG. 3B shows the assembly with the imaging sensor removed so that the bottom of the structure 16 can be seen. The illustrated implementation includes wiring 18 for re-routing electrical contacts.

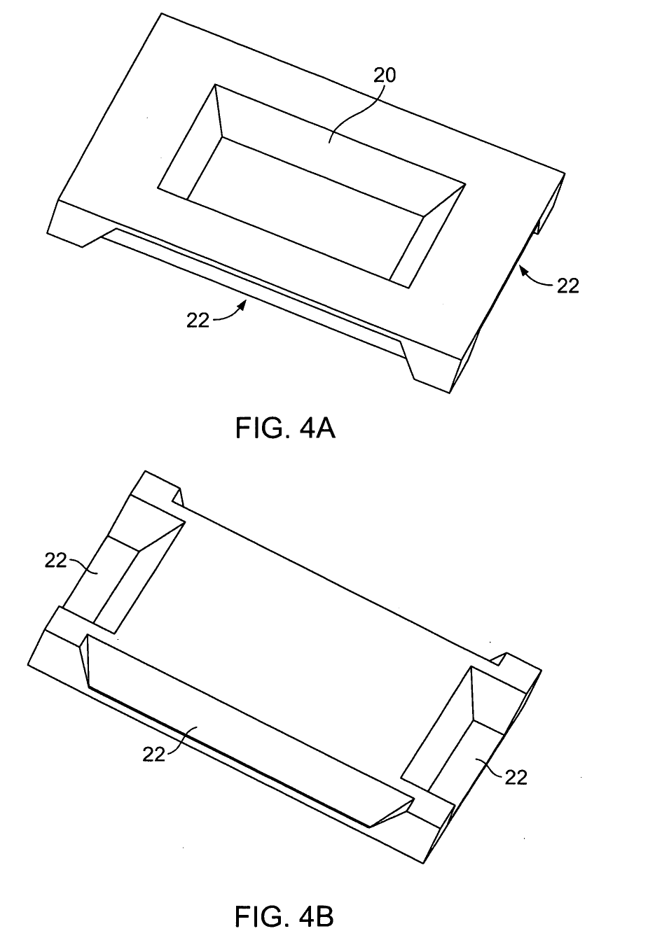

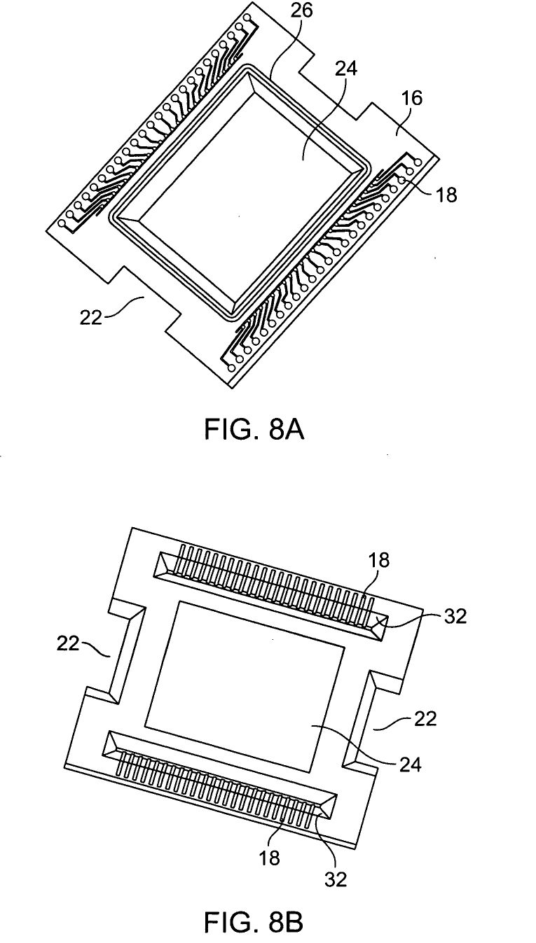

FIGS. 4 through 7 illustrate an example of a fabrication process for the structure 16. Initially, a region of a semiconductor wafer (e.g., a 8-inch diameter silicon wafer with a thickness of 650 μm) is etched to define a cavity 20 for the glass region on one surface (see FIG. 4A) and openings 22 on the second surface (see FIG. 4B). The openings 22 serve as cut-out regions at the periphery of the structure 16 and provide room for self-alignment features 28 on the exterior of the lens barrel 12 to contact the upper surface of the imaging sensor 14 (see FIGS. 3A and 3B). In some implementations, the cut-out regions 22 are located at the periphery along all four sides of the structure 16. In other implementations, the cut-out regions 22 may be present along fewer sides, for example, along only two sides (see FIGS. 8A and 8B). The two surfaces of the silicon wafer may be etched simultaneously, for example, using a KOH wet etch to a depth of about 550 μm. Other depths may be appropriate for particular implementations. In some implementations, the surfaces of the wafer are etched at different times.

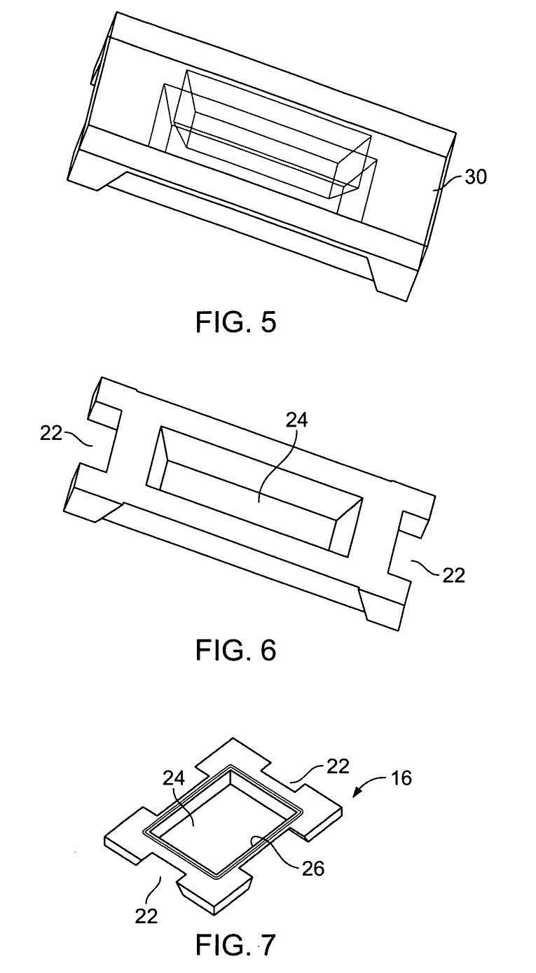

A glass reflow process is performed so that glass flows into the cavity 20 in the surface of the wafer to form a stable, irreversible bond to the silicon (see FIG. 5). In the illustrated implementation, the thickness of the glass 30 above the top surface of the silicon wafer is about 500 μm. Other thicknesses may be appropriate for some implementations.

After the glass reflow process, a double-sided grinding and polishing process is performed. The grinding and polishing process removes the glass material above the cavity and above the upper surface of the silicon wafer and continues to remove silicon material until the openings 22 extend completely through the silicon (i.e., from one surface to the other surface) (see FIG. 6). The grinding and polishing process also removes silicon on the lower surface to reveal the glass window 24. In a particular implementation, about 100 μm of silicon is removed from both surfaces of the wafer. In the illustrated implementation, the thickness of the structure 16 is on the order of several hundred μm (e.g., 350 μm), whereas the height of the lens barrel is on the order of several thousand μm (e.g., 4,810 μm) and the thickness of the image sensor is on the order of about twice that of the structure 16 (e.g., 650 μm). Different dimensions may be appropriate for other implementations.

Electroplating metal is deposited to form a solder sealing ring 26 (FIG. 7) on the back surface of the structure 16 that is to face the imaging sensor 14. The solder sealing ring 26 need not have a circular shape, but may be in the shape, for example, of an oval, a rectangle or other shape. The solder seal ring can be substituted by a seal ring using adhesives. The front surface of the structure 16 subsequently can be attached to the lens barrel 12, for example, using glue or other adhesive. When the imaging sensor 14 is attached to the structure 16 by the solder sealing ring 26, the self-alignment features 28 on the exterior of the lens barrel 12 extend through the openings 22 and contact the upper surface of the imaging sensor 14 (see FIGS. 3A and 3B).

In the foregoing description, formation of the cavity 20 for the glass window 24 and formation of the openings 22 are performed either simultaneously or sequentially at the same stage of the process. However, this need not be the case. For example, in some implementations, a first etch process is performed to form the cavity 20 for the glass window 24. After performing the glass reflow process and the double-sided grinding and polishing process, the openings 22 may be formed by a second etch process.

For applications which include wiring on the structure 16 for re-routing electrical contacts, the process of FIGS. 3 through 7 may be modified to include formation of through-holes and deposition of metal for the wiring. FIG. 8A illustrates an example of wiring 18 on the back surface of the structure 16 that faces the image sensor 14. FIG. 8B illustrates an example of wiring on the front surface of the structure 16 that faces the lens barrel 12. Through-holes 32 (see FIG. 8B) may be formed in the silicon using, for example, a double-sided KOH etch and may be formed at the same time as the openings 22 or cavity 20. The metallization for re-routing the electrical contacts may be provided, for example, using an electroplating technique. The electroplating feed-through metallization technique can seal the through-holes to provide additional protection for the image sensor 14 from dust and other particles.

Some implementations can include one or more of the following advantages. For example, the lens barrel 12 can be placed directly on top of the image sensor 14 covered by the structure 16. The assembly, therefore, can be very small, and the lens assembly can be performed at the wafer level before dicing of the CMOS imager chips. Alignment features 28 on the lens barrel can facilitate alignment of the lens barrel with respect to the image sensor. The camera module does not require a printed circuit board or other intermediate substrate.

The fabrication process can be compatible with standard wire bonding techniques and does not require a reflow process to bond the assembly to a flex circuit or printed circuit board. Therefore, the assembly can be manufactured without high-temperature processes, which can permit attachment of a lens structure made from heat-sensitive polymer prior to board-level attachment. To keep the thermal budget low for the attachment of the structure 16 to the image sensor 14, solder sealing can be performed using, for example, inductive heat. Alternatively, conductive adhesive can be used. Conductive adhesives also can be used to glue the structure 16 to the lens barrel 12.

The silicon/glass composite lid structure 16 can be fabricated as part of a wafer-level process. To facilitate handling of the wafer in which the silicon/glass lid structures 16 are formed, another wafer, which may be referred to as a “handling wafer,” can be used, as explained below.

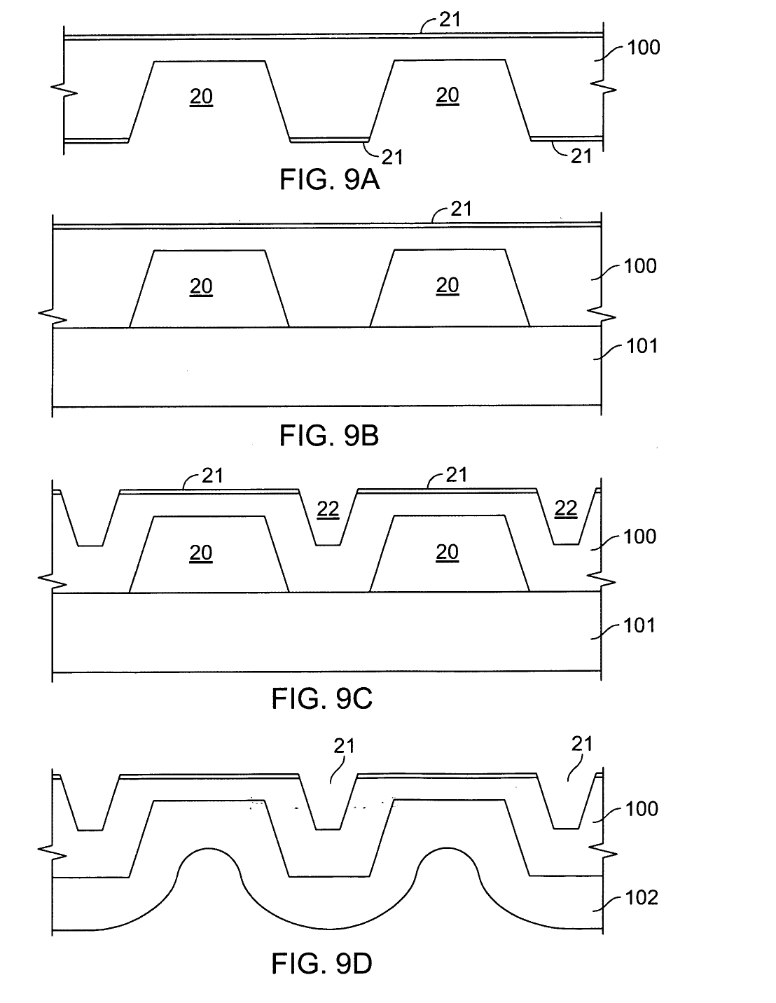

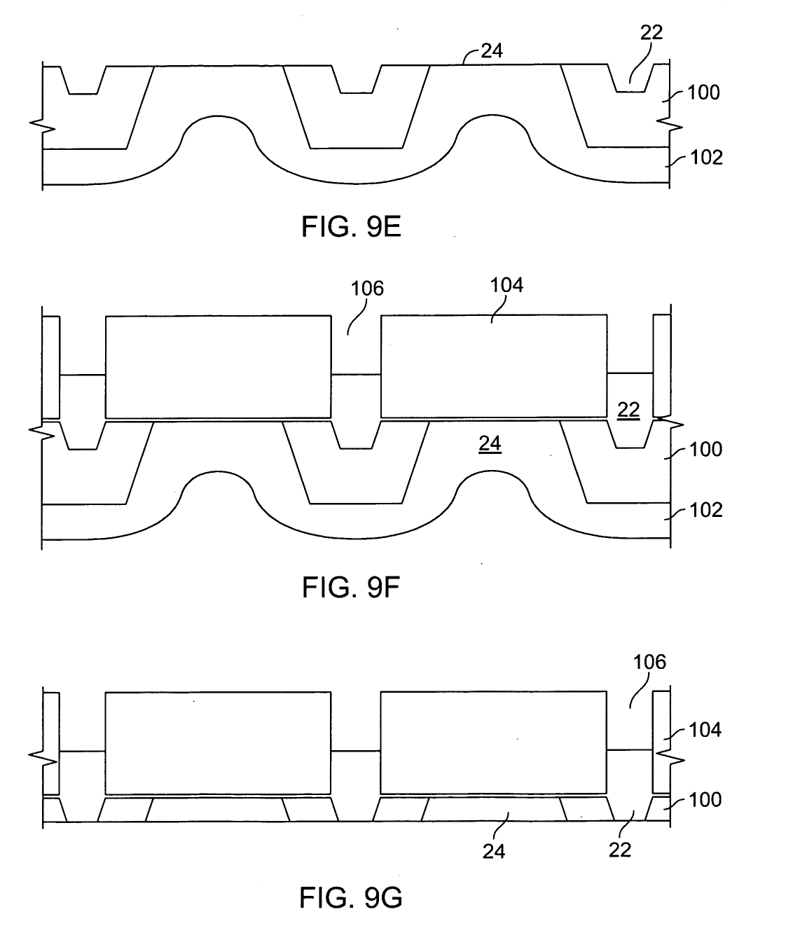

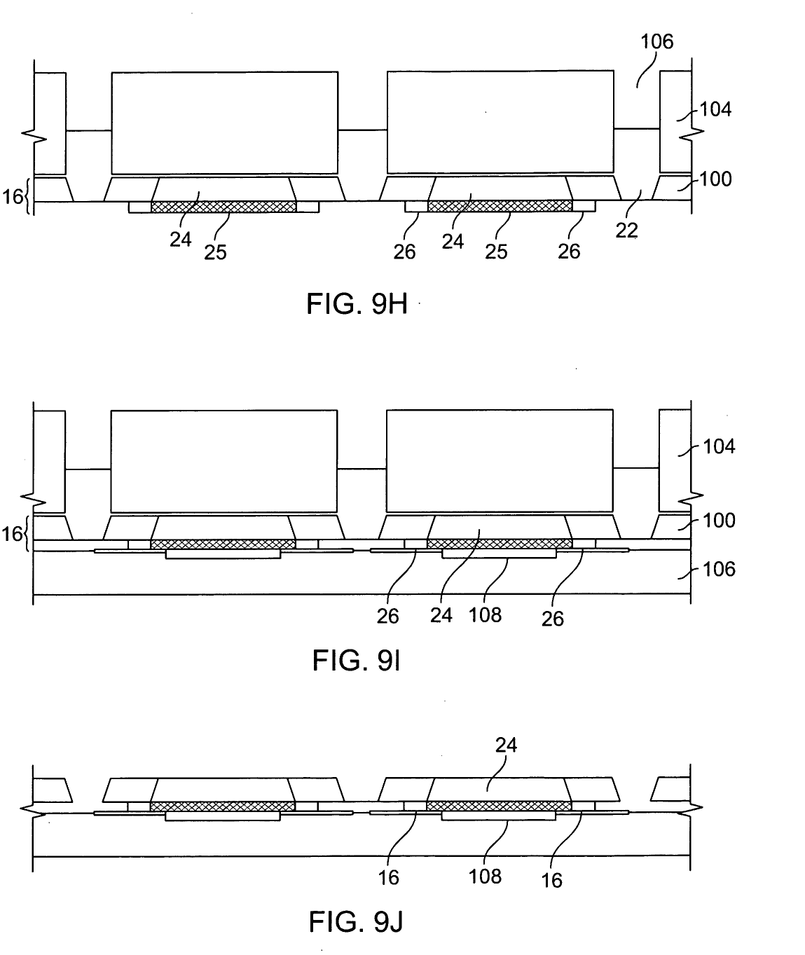

Initially, as shown in FIG. 9A, a semiconductor (e.g., silicon) wafer 100 is etched to define cavities 20 in the front side of the wafer. The cavities 20 define areas for the glass windows which subsequently are formed, as described below. An etch mask 21 is provided on the front side and back side surfaces of the wafer where etching is to be prevented.

After the cavities 20 are formed, the etch mask 21 is removed from the front side of the wafer in which the cavities are formed. As shown in FIG. 9B, a glass wafer 101 is bonded anodically, under vacuum, to the front side surface of the silicon wafer 100. Then, as illustrated in FIG. 9C, the etch mask 21 on the back side of the wafer 100 is patterned and the wafer 100 is etched to form openings 22 (e.g., grooves). During a later fabrication stage, the image sensor assemblies are separated into individual assemblies, for example, by dicing along the grooves 22 to form the cut-out regions that can facilitate passive alignment of the lens barrels and image sensor circuitry. Although the glass wafer 101 may be exposed to etchant (e.g., KOH) during formation of the grooves 22, the thickness of the glass wafer should prevent significant thinning.

Next, the glass wafer 101 is heated to soften the glass so that glass material 102 flows into the cavities 20 (FIG. 9D). A polishing process removes material from the back surface of the wafer 100 in which the grooves 22 are formed so as to reveal the glass window areas 24 (FIG. 9E).

To facilitate handling of the relatively thin silicon/glass structure, a relatively thick handling wafer 104 is attached to the side of the wafer 100 in which the grooves 22 are formed (FIG. 9F). The handling wafer 104 can be attached to the silicon wafer 100, for example, by a soluble adhesive. The handling wafer 104 preferably includes a series of holes 106 aligned above the grooves 22 in the silicon wafer 100. The presence of the holes 106 facilitates subsequent removal of the handling wafer 104 from the silicon/glass composite structure by allowing liquid to access and dissolve the adhesive.

A grinding and polishing process removes material from the front surface of the wafer 100 to reveal the areas in which the grooves 22 (now filled with adhesive) previously were formed (FIG. 9G). Sealing rings 26 and an anti-reflective coating 25 can be provided on the planarized front surface of the silicon/glass structure (FIG. 9H). Next, as illustrated in FIG. 9I, the front surface of the silicon/glass structure is attached to the image sensor wafer 106 (i.e., a semiconductor or other wafer on which image sensor circuitry 108 is formed). The glass windows 24 are aligned above respective image sensor areas, and the sealing rings 26 surround the respective image sensor areas so as to encapsulate each image sensor area. The handling wafer 104 then is removed (FIG. 9J), for example, by dissolving the adhesive that bonds the handling wafer to the back surface of the silicon/glass structure.

Once the handling wafer is removed, the image sensor wafer 108 can be diced or otherwise separated to form individual image sensor assemblies. Attachment of the lens barrels can be performed at the wafer-level prior to the dicing. Alternatively, the lens barrels may be attached after separation of the individual image sensors. The handling wafer 104 can be re-used in subsequent fabrication processes.

In the foregoing implementations, the lid structure 16 that covers the image sensor substrate includes a silicon/glass composite structure in which the transparent window is surrounded along its edges by a semiconductor frame integral with the transparent window. In other implementations, instead of a semiconductor material, the transparent window can be surrounded along its edges by a metal frame (e.g., KOVAR™) that is integral with the transparent window. In that case, a metal frame with cavities 20 and openings 22 can be formed, for example, by a molding or other process.

In some implementations, the lid structure can be formed from a glass wafer without embedding the glass window in semiconductor or metal material. The following paragraphs describe a process by which such a glass lid structure can be fabricated.

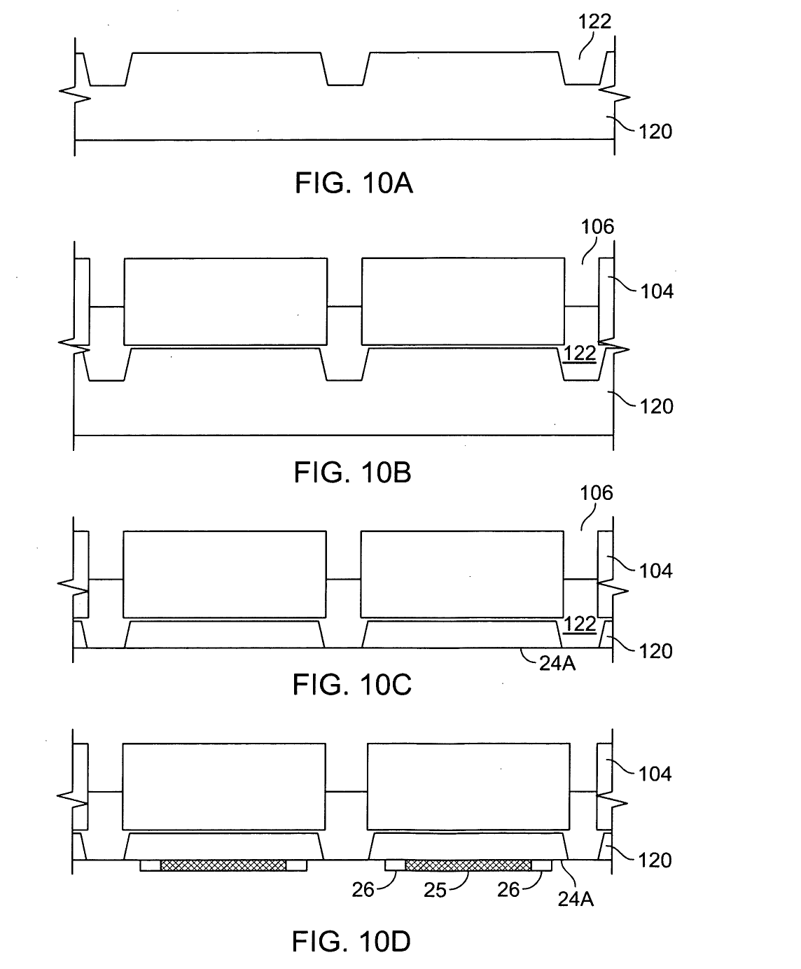

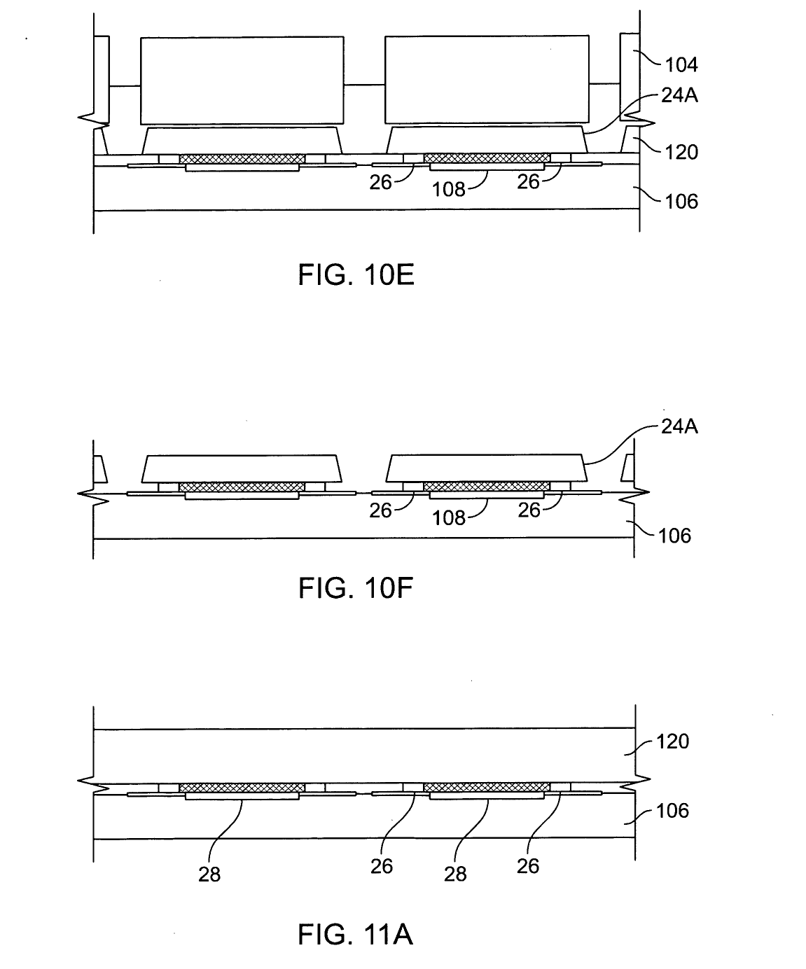

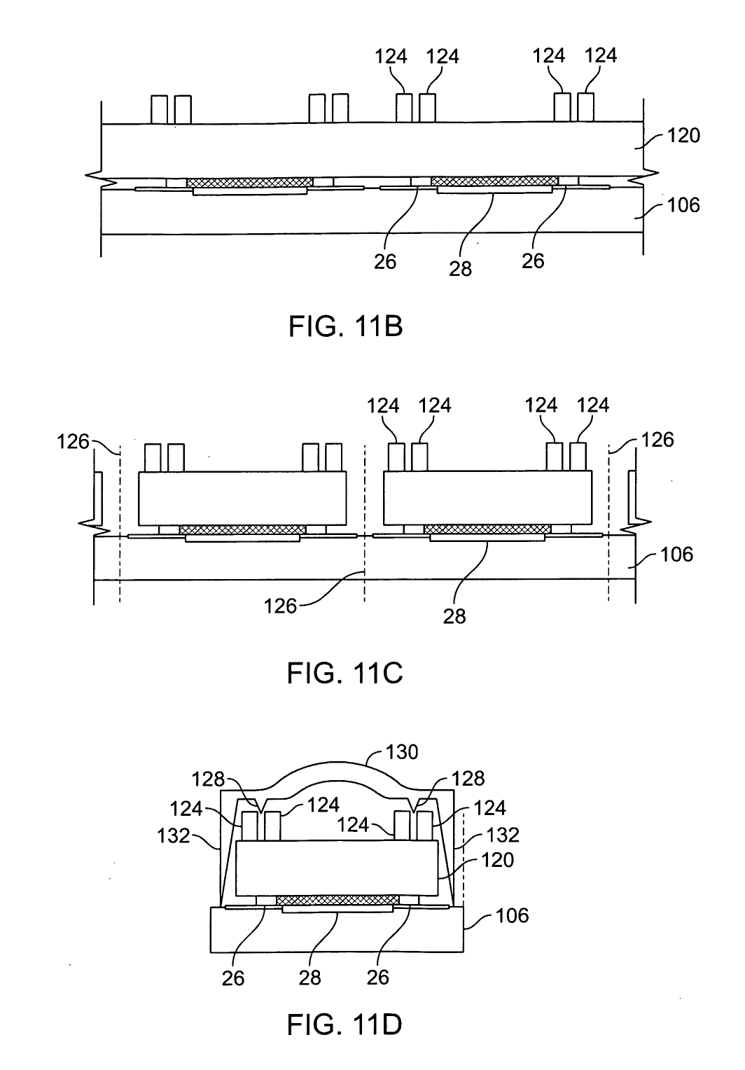

As shown in FIG. 10A, grooves or other indentations 122 are formed in a glass wafer 120. The grooves should be slightly deeper than the final thickness of the lid structure. The grooves 122 can form, for example, an array of lines, a rectangular grid, or a more complex pattern depending on the requirements of the image sensor chip. The grooves 122 can be formed, for example, by etching, sandblasting or other types of processes. Alternatively, the glass wafer may be formed by a molding process that incorporates the grooves 122.

To facilitate handling of the relatively thin glass structure, a relatively thick handling wafer 104 is attached to the side of the glass wafer 120 in which the grooves 122 are formed (FIG. 10B). The handling wafer 104, which can be attached to the glass wafer 120, for example, by a soluble adhesive, preferably includes a series of holes 106 aligned above the grooves 122 in the glass wafer 120. As explained above in connection with FIG. 9D, the presence of the holes 106 facilitates subsequent removal of the handling wafer 104 by allowing liquid to access and dissolve the adhesive.

A grinding and polishing process removes material from the front surface of the glass wafer 120 to reveal the areas in which the grooves 122 (now filled with adhesive) previously were formed (FIG. 10C). The remaining regions 24A of the glass wafer 120 form the windows of the glass lid structure. Sealing rings 26 and an anti-reflective coating 25 can be provided on the planarized front surface of the glass wafer (FIG. 10D). Next, as illustrated in FIG. 10E, the front surface of the glass lid structure is attached to the image sensor wafer 106 (i.e., a semiconductor or other wafer on which image sensor circuitry 108 is formed). The glass windows 24A are aligned above respective image sensor areas, and the sealing rings 26 surround the respective image sensor areas so as to encapsulate each image sensor area. The handling wafer 104 then is removed (FIG. 10F), for example, by dissolving the adhesive that bonds the handling wafer to the back surface of the glass lid structure.

Once the handling wafer is removed, the image sensor wafer 108 can be diced or otherwise separated to form individual image sensor assemblies for attachment to a lens barrel. The lens barrels can be attached at the wafer-level prior to dicing. Alternatively, the lens barrels can be attached individually to the image sensors. The handling wafer 104 can be re-used in subsequent fabrication processes.

Wafer-level processes may be used, for example, to provide square lenses. In addition, the lens closest to the image sensor can be formed integrally with the lens barrel using, for example, a precision molding process, and the lenses can be placed on the covered image sensor during the manufacturing process at the wafer level.

As discussed above, the lid structure 16 can include cut-out regions 22 along its outer periphery, and the lens barrel can include corresponding alignment features 28 that project into the cut-out regions of the lid structure toward the image sensor substrate. Such an arrangement can facilitate three-dimensional alignment of the lens barrel and the image sensor circuitry. In other implementations, alignment in the z-direction (i.e., along the longitudinal axis of the image sensor assembly 10) can be obtained without forming cut-out regions 22 in the lid structure. In such cases, features can be provided on the glass wafer to facilitate alignment of the lens(es) in the x-y plane. The following paragraphs describe formation of such x-y alignment features and formation of the image sensor assembly.

As illustrated in FIG. 11A, a glass wafer 120 is bonded to the image sensor wafer 106 which has individual areas of image sensor circuitry 108. The wafers may be bonded, for example, using adhesive materials or, if solder temperatures can be tolerated, using solder structures 26.

Next, as illustrated in FIG. 11B, mechanical alignment structures 124 are formed on the top surface of the glass wafer 120. Adjacent alignment features 124 are spaced from one another so that a corresponding projection on the lens 130 (see FIG. 11D) can be positioned between the adjacent alignment features. One method of forming the x-y alignment features 124 is to spin-coat a photo-sensitive polymer (e.g., SUB-8) onto the wafer stack and to expose the polymer on a mask aligner tool using optical alignment marks on the image sensor wafer 106 that are visible through the glass wafer 120. Other methods of forming the mechanical alignment structures 124 can include depositing the metal through an electroplating process using a photoresist mask.

In the illustrated implementation, the alignment features 124 are formed after bonding the wafers 120, 106. In other implementations, the alignment features 124 can be formed on the glass wafer before bonding the wafers.

Access to wire bond pads can be provided by removing portions of the glass wafer, for example, through a dicing process. Individual image sensor chips then are formed by dicing the wafer 106 along lines 126 (see FIG. 11C).

As shown in FIG. 11D, a lens 130, with projections 128, is placed over a respective one of the image sensor areas 28. Each projection 128 fits between a pair of the x-y alignment features 124. The lenses 130 may be placed onto the alignment structures 124 either prior to, or after, dicing the image sensor wafer 106 into individual dies. Alignment in the z-direction is provided by downward extending projections 132 on the lens. The projections 132 contact the surface of the image sensor wafer 106 and, thus, determine the distance between the image sensor circuitry 28 and the lens 130. The lens 130 may be made by various techniques, such as polymer molding. Alternatively, if the combined thickness of the glass wafer 120 and the adhesive/solder structures 26 can be controlled to allow adjustment of the z-direction of the lens 130 sufficiently well, projections 132 do not need to contact the surface of the image sensor wafer 106 and can, instead, be designed to rest on the surface of the glass wafer 106.

Other implementations are within the scope of the claims.

What is claimed is:

1. An apparatus comprising a camera module including:
an image sensor substrate including image sensor circuitry;
a lens barrel;
a substantially planar lid structure disposed between, and attached to, the lens barrel and the image sensor substrate, wherein the lid structure includes a transparent window located over image sensor circuitry on the substrate.

2. The apparatus of claim 1 wherein the lid structure includes cut-out regions along its outer periphery, and the lens barrel includes alignment features that project into the cut-out regions of the lid structure toward the image sensor substrate.

3. The apparatus of claim 1 including pairs of alignment features on a surface of the lid structure that engage corresponding projections on a lens in the lens barrel.

4. The apparatus of claim 3 wherein the lens has integral projections that extend along sides of the lid structure and contact an upper surface of the image sensor substrate.

5. The apparatus of claim 1 wherein the transparent window is surrounded along its periphery by a semiconductor frame integral with the transparent window.

6. The apparatus of claim 5 wherein the semiconductor material comprises silicon.

7. The apparatus of claim 5 wherein the transparent window comprises glass.

8. The apparatus of claim 5 wherein respective surfaces of the semiconductor frame and the transparent window that face the lens barrel are in substantially the same plane as one another, and wherein respective surfaces of the semiconductor frame and the transparent window that face the image sensor are in substantially the same plane as one another.

9. The apparatus of claim 1 wherein the transparent window is surrounded along its periphery by a metal frame integral with the transparent window.

10. The apparatus of claim 9 wherein the transparent window comprises glass.

11. The apparatus of claim 9 wherein respective surfaces of the metal frame and the transparent window that face the lens barrel are in substantially the same plane as one another, and wherein respective surfaces of the metal frame and the transparent window that face the image sensor are in substantially the same plane as one another.

12. The apparatus of claim 1 wherein the camera module includes feed-through metallization that extends through the lid structure from a first surface of the lid structure that faces the image sensor substrate to a second surface of the lid structure that faces the lens barrel.

13. The apparatus of claim 1 wherein a thickness of the lid structure is on the order of several hundred microns.

14. A method of fabricating a camera module, the method comprising:
providing a substantially planar lid structure including a transparent window;
attaching a first surface of the lid structure to an image sensor substrate such that the transparent window is positioned over image sensor circuitry on the substrate and attaching a second surface of the lid structure to a lens barrel, such that the lid structure is disposed between the lens barrel and the image sensor substrate.

15. The method of claim 14 wherein at least the following are performed in a wafer-level process:
forming the substantially planar lid structure; and
attaching the first surface of the lid structure to an image sensor substrate.

16. The method of claim 15 wherein forming the substantially planar structure includes:
attaching a handling wafer to a first wafer from which the lid structure is to be formed;
reducing the thickness of the first wafer while the handling wafer is attached; and
subsequently removing the handling wafer.

17. The method of claim 16 wherein the first wafer is glass.

18. The method of claim 16 wherein the first wafer comprises areas of glass each of which is surrounded along its respective periphery by a semiconductor material.

19. The method of claim 16 wherein the first wafer comprises areas of glass each of which is surrounded along its respective periphery by metal.

20. The method of claim 17 wherein attaching a handling wafer includes attaching the handling wafer to the first wafer using a soluble adhesive.

21. The method of claim 20 wherein the handling wafer includes holes aligned above openings in the first wafer, wherein removing the handling wafer includes providing a liquid through the holes to dissolve the adhesive.

22. The method of claim 15 including separating the image sensor substrate into individual image sensor assemblies.

23. The method of claim 14 wherein the lid structure includes cut-out regions along its outer periphery and wherein the lens barrel includes corresponding alignment features, wherein the method includes:
aligning the alignment features with corresponding ones of the cut-out regions.

24. The method of claim 14 wherein providing the lid structure includes:
forming a cavity in a first side of a semiconductor wafer;
filling the cavity with a transparent material that bonds to the semiconductor wafer; and
removing semiconductor material and transparent material from the first side and an opposite second side so that a substantially planar structure is formed in which the transparent material is exposed on both sides and wherein a periphery of the transparent material is surrounded by semiconductor material.

25. The method of claim 14 wherein providing the lid structure includes:
etching a cavity in a first side of a semiconductor wafer;
filling the cavity with a transparent material;
removing semiconductor material from a second side of the semiconductor material to reveal the transparent material.

26. The method of claim 25 including causing the transparent material in the cavity to bond to the semiconductor wafer.

27. The method of claim 25 further including:
removing transparent material from above a surface of the semiconductor wafer in which the cavity is formed.

28. The method of claim 27 including using a double-sided etch to simultaneously form the cavity in the first side and openings in the second side.

29. The method of claim 14 further including forming the lens barrel with an integral lens through a precision molding process.
